(19) United States
(12) Patent Application Publication
(10) Pub. No.: US 2026/0064571 A1
(43) Pub. Date: Mar. 5, 2026

(54) Generating Test Suites For Testing Code Modules

(71) Applicant: Oracle International Corporation, Redwood Shores, CA (US)

(72) Inventors: Mahinthan Chandramohan, Brisbane (AU); Meng Chen, Melbourne (AU); Jovan Jancic, Vienna (AT); Cong Duy Vu Hoang, Melbourne (AU); Padmanabhan Krishnan, Gold Coast (AU); Mahdi Kazemi Moghaddam, Sydney (AU); Philip Arthur, Sydney (AU); Don Dharmasiri, Victoria (AU); Thanh Long Duong, Point Cook (AU)

(73) Assignee: Oracle International Corporation, Redwood Shores, CA (US)

(21) Appl. No.: 18/936,052

(22) Filed: Nov. 4, 2024

Related U.S. Application Data
(60) Provisional application No. 63/690,938, filed on Sep. 5, 2024.

(51) Int. Cl. G06F 11/36

(52) U.S. Cl. CPC G06F 11/3684; G06F 11/3688

(57) ABSTRACT

A system accesses a code module that includes one or more units of code and instructs a machine learning model to generate a test suite based on a specification for the code module. The test suite includes tests for testing the code module to verify that one or more units of code successfully execute in accordance with the specification. The specification includes preconditions that precede successful execution of the one or more units of code and postconditions that exist following successful execution of the one or more units of code. The machine learning model generates the test suite. The system receives the test suite from the machine learning model. The system stores and/or transmits the test suite for use in testing the code module.

### INCORPORATION BY REFERENCE; DISCLAIMER

The following application is hereby incorporated by reference: application No. 63/690,938, filed on Sep. 5, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to generating test suites for testing code modules. More particularly, the present disclosure relates to utilizing machine learning models to generate test suites for testing code modules.

### BACKGROUND

Test suites are generated for testing code modules to ensure that the code modules function as intended under various conditions. Test suites include sets of tests for systematically exercising the code of the code module with a range of inputs. The tests help to identify bugs and inconsistencies before the code module is deployed. Test suites may include a unit test that includes a set of tests for testing operations of a particular function or method, for example, in isolation from other aspects of a software application. Unit tests help catch issues at an early stage, making it easier to pinpoint the location of a problem and reducing the complexity of debugging efforts. Additionally, test suites may include a set of tests for testing edge cases. The edge cases may include scenarios that are at the extreme ends of input ranges and/or that involve unusual conditions that may arise infrequently during regular use of the code module. Testing edge cases helps reveal bugs or unanticipated behaviors. By ensuring that code modules handle both normal operations and edge cases correctly, test suites provide improved confidence in the reliability and robustness of software applications.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram that depicts an example computing architecture for a system in accordance with one or more embodiments;

FIGS. 2A-2C illustrate example operations associated with utilizing machine learning models to generate test suites for testing code modules in accordance with one or more embodiments; and

FIG. 3 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE SYSTEM ARCHITECTURE
3. EXAMPLE OPERATIONS
4. EXAMPLE EMBODIMENTS
5. COMPUTER NETWORKS AND CLOUD NETWORKS
6. MICROSERVICE APPLICATIONS
7. HARDWARE OVERVIEW
8. MISCELLANEOUS; EXTENSIONS

### 1. GENERAL OVERVIEW

One or more embodiments utilize machine learning models to generate test suites that include test code for testing a code module. The test suites are generated based on a specification for the code module. The code module includes one or more units of code. The test suite includes a set of tests for testing the code module to verify that the one or more units of code successfully execute in accordance with the specification. The specification for the code module may be generated by the machine learning model prior to generating the test suite for the code module. Additionally, or alternatively, the specification may be provided as an input to the machine learning model. The specification includes preconditions that precede successful execution of the one or more units of code and postconditions that exist following successful execution of the one or more units of code. The tests may include unit tests that are executed upon code modules to test normal conditions and/or edge cases that may be encountered by the code module.

In one example, a machine learning system generates a plain language explanation of a specification for a code module based at least in part on one or more examples that include an example code module and an example formal specification for the example code module. The machine learning system may generate the test suite based at least in part on the plain language explanation of the specification. Additionally, or alternatively, the machine learning system may generate a plain language explanation of a set of edge cases based at least in part on the one or more examples that include an example code module and an example formal specification for the example code module. The machine learning system may generate the test suite based at least in part on the plain language explanation of the set of edge cases.

In one example, the system utilizes a machine learning model that is trained to generate a test suite for a code module based on a single input prompt to the machine learning model. The input prompt may instruct the machine learning model to utilize chain of thought reasoning (CoT reasoning). The CoT reasoning performed by the machine learning model may include generating a specification for the code module and/or a description of the tests to be performed upon the code module prior to generating the test suite for the code module. After generating the specification and/or the description of tests, the machine learning model generates the test suite for the code module based on the specification and the description of tests. The test suite may include executable code for executing the tests on the code module.

In one example, the system utilizes one or more machine learning models to generate a test suite for a code module using a multi-prompt process. The system may construct a first prompt that includes a code module and an instruction for a machine learning model to generate a specification for the code module and a description of tests to be performed upon the code module. The system may receive an output that includes the specification and the description of tests. The system may construct a second prompt for the machine learning model to generate the test suite based on the specification and the description of tests that were included in the first output. The machine learning model may generate a second output that includes the test suite. In one example, the system compiles a training dataset that includes inputs and outputs from the multi-prompt process. The system utilizes the training dataset to train a machine learning model to generate a test suite based on a single input prompt, for example, utilizing CoT reasoning.

One or more embodiments described in this Specification and/or recited in the claims may not be included in this General Overview section.

### 2. EXAMPLE SYSTEM ARCHITECTURE

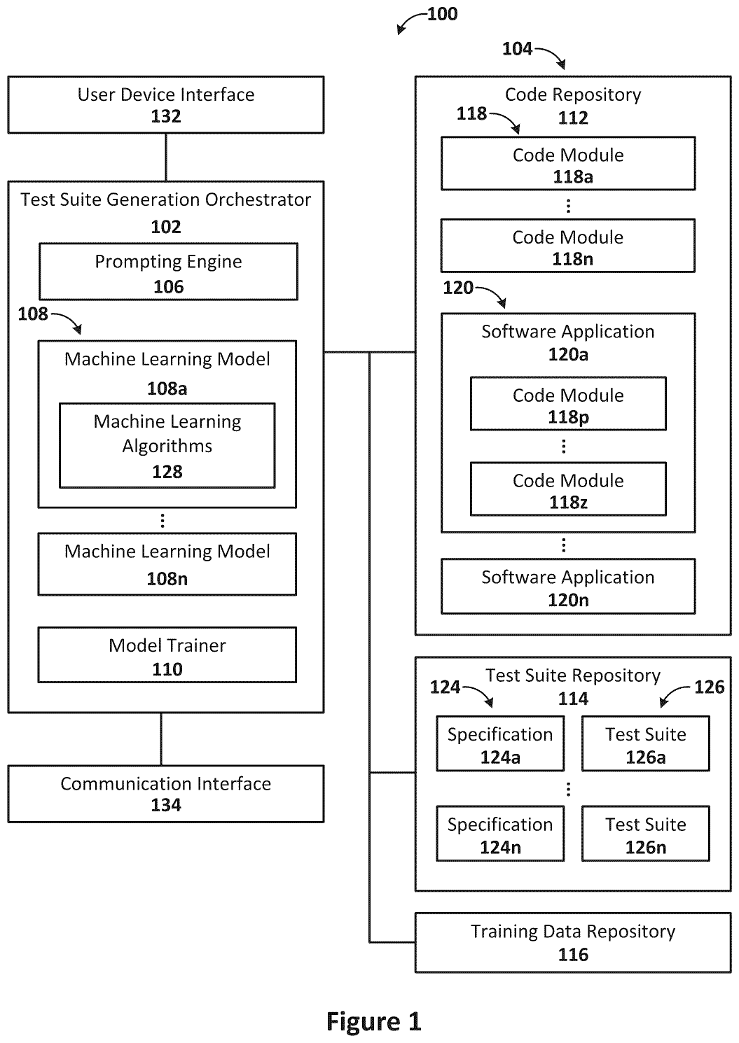

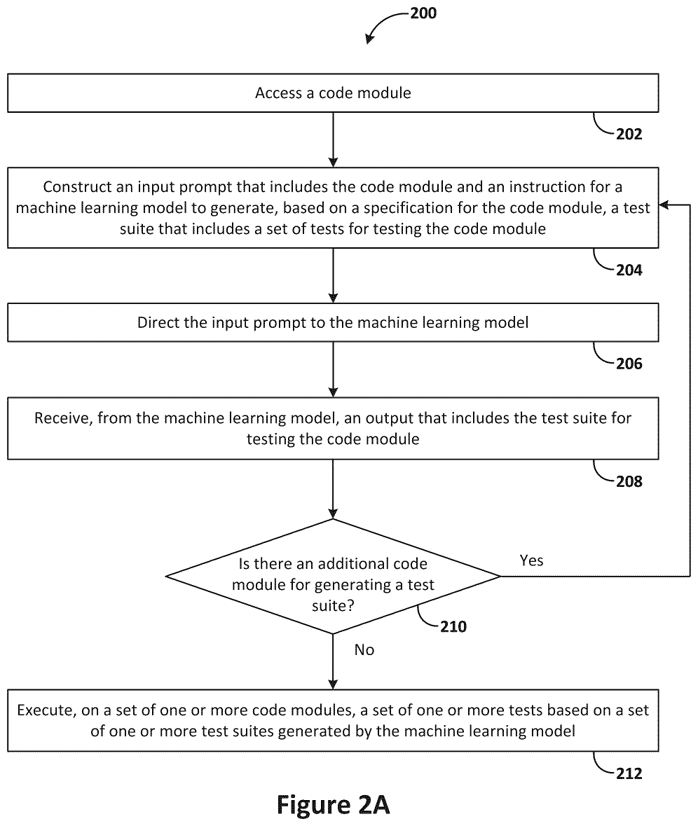

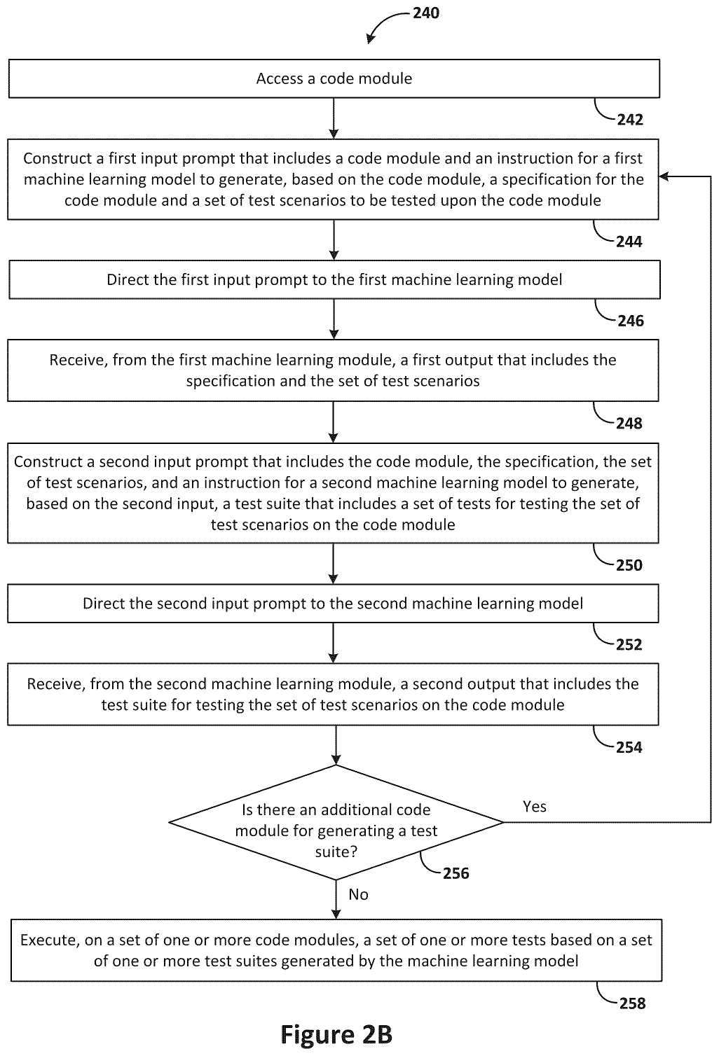

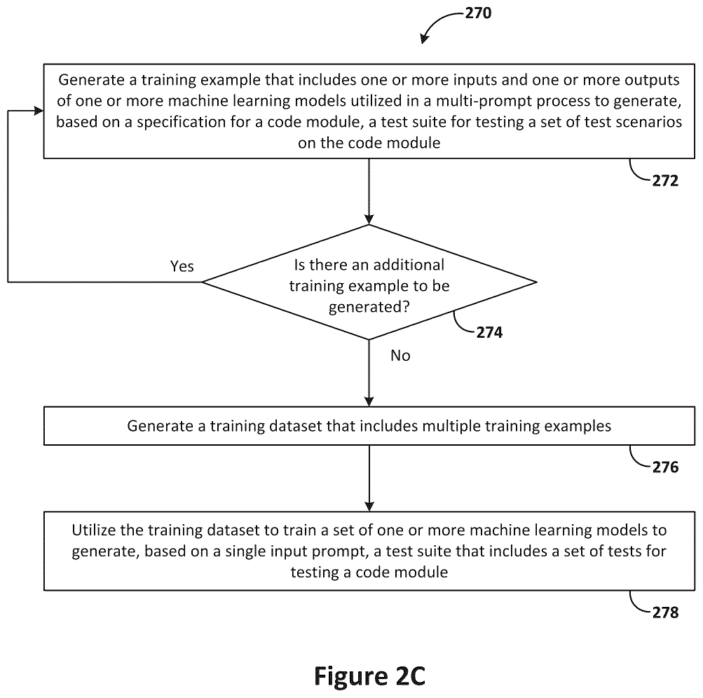

FIG. 1 illustrates a test suite generation system 100 accordance with one or more embodiments. As shown in FIG. 1, the system 100 includes a test suite generation orchestrator 102 and one or more data repositories 104. In one or more embodiments, the test suite generation orchestrator 102 refers to hardware and/or software configured to perform operations described herein. The test suite generation orchestrator performs operations associated with utilizing the one or more machine learning models to generate test suites that include a set of tests for testing code modules. Examples of operations are further described below with reference to FIGS. 2A-2C.

As shown in FIG. 1, the test suite generation orchestrator 102 includes a prompting engine 106, a set of one or more machine learning models 108, and a model trainer 110. The one or more data repositories 104 include a code repository 112, a test suite repository 114, and a training data repository 116. The code repository 112 includes a set of one or more code modules 118, such as code module 118a and code module 118n. Additionally, or alternatively, the code repository 112 may include a set of one or more software applications 120, such as software application 120a and software application 120n. The one or more software applications 120 may include one or more code modules 118. For example, as shown in FIG. 1, software application 120a includes code module 118p and code module 1182. The test suit repository 114 includes outputs from one or more of the machine learning models 108. The outputs may include specifications 124 and/or test suites 126 for code modules 118. The specifications 124 and the test suits 126 are generated by one or more of the machine learning models 108. In one example, shown in FIG. 1, the test suite repository 114 includes specification 124a and test suite 126a corresponding to specification 124a. Additionally, the test suite repository 114 includes specification 124n and test suite 126n corresponding to specification 124n. In one example, specification 124a and test suite 126a correspond to code module 118a, and specification 124n and test suite 126n correspond to code module 118n.

The prompting engine 106 of the test suit generation orchestrator 102 generates input prompts for one or more of the machine learning models 108 to generate specifications 124 and/or test suites 126 for code modules 118. The test suit generation orchestrator 102 provides the input prompts to the machine learning models 108. The input prompts may include one or more code modules 118 and/or a reference to a location of one or more code modules 118 in the code repository 112. Additionally, or alternatively, the input prompts may include instructions for one or more machine learning models 108. The input prompts may include instructions to generate a specification 124 for a code module 118. Additionally, or alternatively, the input prompts may include instructions to generate a test suite 126 for a code module 118, for example, based on a specification 124 for the code module 118. The instructions to generate the test suite 126 for the code module 118 may include the specification 124 for the code module 118. Additionally, or alternatively, the input prompts may include instructions to, first, generate a specification 124 for a code module 118 and to, second, generate a test suite for the code module 118, for example, using CoT reasoning.

In one example, the test suite generation system 100 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

In one or more embodiments, the test suite generation system 100 may include more or fewer components than the components described herein. The components described herein may be local to or remote from each other. The components described herein may be implemented in software and/or hardware. The components described herein may be distributed over multiple applications and/or machines. Multiple components may be combined into one application and/or machine. Operations described with respect to one component may instead be performed by another component. Additional embodiments and/or examples relating to computer networks are described below in Section 5, titled “Computer Networks and Cloud Networks.”

### A. Example Data Repositories.

The test suite generation system 100 includes one or more data repositories 104 that store code modules 118. The test suite generation orchestrator 102 provides the code modules 118 as input prompts to one or more machine learning models 108 that generate test suites 126 that include tests for testing code modules 118. The one or more data repositories 104 may also include the test suites 126 generated by the one or more machine learning models 108. The test suite generation orchestrator 102 may receive the test suites 126 as outputs from the one or more machine learning models 108 and may store the test suites 126 in the one or more data repositories 104, for example, in association with the code modules 118 to be tested by the test suites 126. Additionally, or alternatively, the one or more data repositories 104 may include training data for training the one or more machine learning models.

In one or more embodiments, a data repository 104 includes any type of storage unit and/or device (e.g., a file system, database, collection of tables, or any other storage mechanism) for storing data. Furthermore, a data repository 104 may include multiple different storage units and/or devices. The multiple different storage units and/or devices may or may not be of the same type or located at the same physical site. Furthermore, a data repository may be implemented or executed on the same computing system as the test suite generation system 100. Additionally, or alternatively, the data repository 104 may be implemented or executed on a computing system separate from the test suite generation system 100. The data repository may be communicatively coupled to the test suite generation system 100 via a direct connection or via a network.

### 1. Example Code Modules

In one example, a data repository 104 includes code modules 118. The test suite generation orchestrator 102 may access the code modules 118 in the data repository 104 and provide input prompts to one or more machine learning models 108 that include the code modules 118. Additionally, or alternatively, the test suite generation orchestrator 102 may receive code modules 118 as inputs from one or more computing devices. The code modules 118 may be provided by the one or more computing devices with a request for the test suite generation orchestrator 102 to generate a test suite 126 for the code modules 118. A requests to generate a test suite 126 may include one or more code modules 118. The request may identify one or more test suites 126 to be generated for a code module 118.

A code module 118 may include a self-contained segment or unit of code. The code module 118 may include one or more functions, classes, or files that encapsulate one or more functionalities. A code module 118 may include one or more procedures or subroutines. A code module 118 may include one or more code blocks that include multiple functions or methods that work together to perform a specific task. In one example, a code module 118 is a stand-alone segment or unit of code. In one example, a code module 118 is a segment or unit of code from a software application 120.

### 2. Example Specifications

A specification 124 describes what a code module should do. A specification 124 may include a formal specification and/or a plain language description of the specification 124. A formal specification includes a formal language or notation that describes the behavior, constraints, and/or properties of a code module. In one example, a formal specification conforms to a Java modeling language (JML) protocol. A specification 124 that conforms to a JML protocol may be referred to as a JML specification. In one example, a formal specification conforms to a Z Notation modeling language protocol. A specification 124 that conforms to a Z Notation modeling language protocol may be referred to as a Z specification. In one example, a formal specification conforms to an Alloy modeling language protocol. A specification 124 that conforms to an Alloy modeling language protocol may be referred to as an Alloy specification. In one example, a formal specification is machine checkable. The system 100 may machine-check a specification 124 to verify the contents of the specification 124. The system 100 may check the specification 124 to ensure that the specification 124 is logically consistent, meets certain correctness criteria, and satisfies the intended properties of the system being modeled. A plain language specification refers to a description of a formal specification and/or an informal description of the behavior, constraints, and/or properties of a code module 118.

A specification 124 for a code module 118 includes at least a set of preconditions and a set of one or more postconditions. A specification 124 for a software application 120 may include at least a set of preconditions and a set of post conditions for multiple code modules 118 of the software application 120. The preconditions define one or more conditions that precede successful execution of a code module 118. The preconditions are required to be satisfied before the code module 118 is executed for the code module 118 to function successfully. The code module 118 depends upon the preconditions to commence execution and/or to execute correctly. The preconditions may specify what inputs are valid and/or what state the system is required to be in for the code module 118 to function correctly. Preconditions may be imposed upon a caller of the code module 118. The postconditions define one or more conditions that exist following successful execution of a code module 118. The postconditions are satisfied when the code module 118 has successfully completed execution. Post conditions may be imposed upon the code module 118. The postconditions define one or more expected outcomes and/or one or more state changes resulting from executing the code module 118. Additionally, or alternatively, a specification 124 for a code module 118 and/or a software application 120 may include one or more of the following: performance constraints, invariants, input/output description, or error handling. The performance constraints define the expected efficiency or resource usage limits, such as time, memory, or throughput, under specific conditions. The invariants define conditions or properties that exist throughout the successful execution of the code module 118, for example, regardless of the state transitions. The input/output description defines what are valid inputs to the code module 118 and what are valid outputs that the code module 118 may produce. The error handling defines how the code module 118 should behave or recover when the code module 118 encounters an unexpected condition or invalid input.

### 3. Example Test Suites

A test suite 126 includes a set of tests for verifying that a code module 118 functions in accordance with a specification 124 for the code module 118. Additionally, or alternatively, a test suite 126 may include a set of tests for verifying that a software application 120 functions in accordance with a specification 124 for the software application 120. For example, a test suite 126 may include sets of tests for verifying that multiple code modules 124 of a software application 120 function in accordance with a specification 124. The test suites 126 generated by the machine learning models 108 may include one or more of the following: a unit test, an integration test, a system test, a functional test, an end-to-end test, or a regression test.

A unit test may include a set of tests for verifying operations of a particular function or method within a code module 118 and/or software application 120. The unit test may determine whether a specific “unit” of code works as expected, for example, independent from other parts of the code module 118 and/or software application 120. A unit test may include unit test code. The unit test code includes code for performing the unit test. The unit test code may include test cases that provide inputs to the code module 118 and/or software application 120 being tested and that assert whether outputs corresponding to the inputs are correct.

An integration test may include a set of tests for verifying interactions between multiple units or components to ensure they work together as expected. An integration test may test connections between different units. For example, an integration test may test how different functions, classes, or modules interact with one another. An integration test may include an integration test code. The integration test code includes executable code for performing the integration test. The integration test code may include test cases that provide inputs to the code module 118 and/or software application 120 being tested and that assert whether outputs corresponding to the inputs are correct.

A system test may include a set of tests for testing a complete and/or integrated software system to verify that it meets the specified requirements. A system test may encompass a set of components and modules that represent a complete and/or integrated software system. The complete and/or integrated software system may represent all or a subset of a software application 120. In one example, a system test includes a function test for testing one or more functionalities of the software application 120 by verifying that a particular feature or functionality works according to a specification 124. The functional tests can be performed at various levels, such as for one or more individual functions, a subsystem of the software application 120, or the software application 120 as a whole. Additionally, or alternatively, a system test may include an end-to-end test that tests scenarios across the software application 120 from start to finish. The system test may validate whether the software application 120 operates as expected across a set of components, systems, and/or external interfaces. A system test may include system test code. The system test code includes code for performing the system test. The system test code may include test cases that provide inputs to the code module 118 and/or software application 120 being tested and that assert whether outputs corresponding to the inputs are correct.

A regression test may include a set of tests for testing features of a code module 118 and/or software application 120 to verify whether they function correctly after changes, such as bug fixes or new feature additions. A regression test may be configured as a unit test, an integration test, and/or a system test. A regression test may include regression test code. The regression test code includes executable code for performing the regression test. The regression test code may include test cases that provide inputs to the code module 118 and/or software application 120 being tested and that assert whether outputs corresponding to the inputs are correct.

The test suites 126 may include tests that are configured for testing normal conditions and/or edge cases. The test suite 126 may include tests for testing a code module 118 and/or a software application 120 under normal conditions to verify that the code module 118 and/or software application 120 operate according to a specification 124 under normal conditions. The edge cases may test a code module 118 and/or software application 120 based on edge cases to verify that the code module 118 and/or software application 120 operate according to a specification 124 under conditions that represent limits of the code module 118 or software application 120 and/or that go beyond limits of the code module 118 or software application 120. The edge cases may test operations of the code module 118 and/or software application 120 under abnormal and/or extreme scenarios. The edge cases may test boundaries of what the code module 118 and/or software application 120 is intended to handle. Testing edge cases helps ensure the robustness and reliability of the code module 118 and/or software application 120.

In one example, an edge case is configured to test a function that processes a numerical value. The edge case may test for a minimum and/or a maximum value (e.g., 0, negative numbers, very large numbers). Additionally, or alternatively, an edge case may be configured to test a function that processes a string. The edge case may test for one or more of the following: an empty string, a lengthy string, a string with one or more particular characters. Additionally, or alternatively, an edge case may be configured to test an array. The edge case may test one or more of the following: an empty array, an array with a single element, an array with a large number of elements, and/or an array with one or more particular elements.

### B. Example Machine Learning Models.

The test suite generation system 100 includes one or more machine learning models 108. The one or more machine learning models 108 are trained based on training data, for example, from the training data repository 116. The one or more machine learning models 108 generate a test suite 126 based on a specification 124 for a code module 118. In one example, the test suite generation system 100 provides a code module 118 as an input prompt to a machine leaning model 108, and the machine learning model 108 generates the specification based on the code module 118. Additionally, or alternatively, the test suite generation system 100 may provide the specification 124 to a machine learning model 108 as an input prompt, for example, together with the code module 118, and the machine learning model 108 generates the test suite 126 based on the specification 124 and the code module 118. In one example, one or more machine learning models 108 generate a test suite for testing a code module 118 based on a single input prompt. The machine learning models 108 may utilize CoT reasoning to generate the test suite 126, for example, based on a single input prompt. Example operations for generating a test suite 126 based on a single input prompt are described below with reference to FIG. 2A. An example input prompt for a machine learning model 108 to generate a test suite 126 based on a single input prompt is described below in Section 4(D), titled “Example Single Input Prompt For Generating A Test Suite.” An example test suite 126 generated by a machine learning model 108 based on a single input prompt is described below in Section 4(E), titled “Example Test Suite Generated By A Machine Learning Model.”

In one example, one or more machine learning models 108 may generate a test suite 126 for testing a code module 118 based on multiple input prompts such as a series of input prompts. In one example, a first machine learning model 108 generates a first output that includes a specification 124 for a code module 118 and a set of test scenarios to be tested upon the code module 118. The first machine learning model 108 generates the first output based on a first input prompt that includes the code module 118 and an instruction to generate the specification 124 and the set of test scenarios based on the code module 118. Additionally, or alternatively, a second machine learning model 108 generates the test suite 126 based on a second input that includes at least a portion of the first output. The second input may include the code module 118, the specification 124, the set of test scenarios, and an instruction to generate the test suite 126 based on the code module 118, the specification 124, and the set of test scenarios. Example operations for generating a test suite 126 based on multiple input prompts, such as a series of input prompts, are described below with reference to FIG. 2B. An example series of input prompts for generating a test suite 126 are described below in Sections 4(A) and 4(C), titled “Example Input Prompt For Generating A Specification And Edge Cases” and “Example Input Prompt For Generating A Test Suite,” respectively. An example output from a machine learning model 108 corresponding to the input prompt described in Section 4(A) is described below in Section 4(B), titled “Example Specification And Edge Cases Generated By A Machine Learning Model.” An example output from a machine learning model 108 corresponding to the input prompt described in Section 4(C) is described below in Section 4(E), titled “Example Test Suite Generated By A Machine Learning Model.”

A machine learning model 108 may include one or more machine learning algorithms 128, such as supervised algorithms and/or unsupervised algorithms. Various types of algorithms may be used, such as linear regression, logistic regression, linear discriminant analysis, classification and regression trees, naïve Bayes, k-nearest neighbors, learning vector quantization, support vector machine, bagging, and random forest, boosting, backpropagation, and/or clustering. In one example, one or more machine learning models include a large language model (LLM), such as a strong LLM, a general purpose LLM, a specialized LLM, a mulita-lingual LLM, a task-specific LLM, an interactive LLM, a dialogue-based LLM, or a robust LLM. Additionally, or alternatively, the test suite generation system 100 may utilize one or more classical models. A classical model may include one or more classical statistical algorithms that rely on a set of assumptions about one or more of the underlying data, the data generating process, or the relationships between the variables. Example classical statistical algorithms may include linear regression, logistic regression, analysis of variance (ANOVA), or hypothesis testing.

In one example, a machine learning algorithm 128 can be iterated to learn a target model f that best maps a set of input variables to an output variable. In particular, a machine learning algorithm 128 may be configured to generate and/or train a machine learning model 108. A machine learning algorithm 128 may be iterated to learn a target model f that best maps a set of input variables to an output variable using a set of training data. Training data used by a machine learning algorithm 128 may be stored in the training data repository 116. The training data may include datasets and associated labels. The datasets may be associated with input variables for the target model f. The associated labels may be associated with the output variable of the target model f. The training data may be updated based on, for example, feedback on the accuracy of the current target model f. Updated training data may be fed back into the machine learning algorithm 128 that in turn updates the target model f.

A machine learning algorithm 128 may generate a target model f such that the target model f best fits the datasets of training data to the labels of the training data. Additionally, or alternatively, a machine learning algorithm 128 may generate a target model f such that when the target model f is applied to the datasets of the training data, a maximum number of results determined by the target model/matches the labels of the training data. Different target models may be generated based on different machine learning algorithms 128 and/or different sets of training data.

In one example, the test suite generation system 100 may include a model trainer 110 that utilizes one or more machine learning algorithms 128 to generate and/or train a machine learning model 108. In one example, the model trainer 110 may obtain and/or generate feedback from one or more of the machine learning models 108. The model trainer 110 may train, update, and/or retrain one or more of the machine learning models 108 based at least in part on the feedback. The feedback may correspond to one or more outputs of at least one machine learning model 108. In one example, the model trainer 110 may obtain multiple training datasets. The model trainer 110 may train a machine learning model 108 utilized by the test suite generation system 100 based at least in part on the multiple training datasets.

The training datasets may include datasets from the training data repository 116, such as groups of inputs and outputs of machine learning models 108. In one example, a machine learning model 108 may be trained to generate a test suite 126 for testing a code module 118 based on training data that includes inputs and outputs from a set of one or more machine learning models 108 utilized to generate the test suite 126 based on a series of input prompts. Example operations for training a machine learning model 108 are described below with reference to FIG. 2C. A training example that may be included in a training dataset for training a machine learning model 108 is described below in Section 4(F), titled “Training Example For Training A Machine Learning Model To Generate A Test Suite.”

In one example, the training data may include one or more initial supervised learning datasets. The model trainer 110 may train a machine learning model 108 based at least in part on the one or more initial supervised learning datasets. In one example, the training data may include one or more subsequent supervised learning datasets. The model trainer may update or retrain the machine learning model 108 based on one or more subsequent supervised learning datasets. The one or more subsequent supervised learning datasets may be generated based at least in part on feedback corresponding to one or more outputs of the machine learning model 108.

### C. Example System Interfaces

The system may include a user device interface 132 communicatively coupled or couplable with the test suite generation system 100. The user device interface 132 may include hardware and/or software configured to facilitate interactions between a user and various aspects of the system 100. The user device interface 132 may render user interface elements and receive input via user interface elements. For example, the user device interface 132 may display outputs generated by the test suite generation system 100. Additionally, or alternatively, the user device interface 132 may be configured to select datasets as inputs to the test suite generation system 100. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by the user device interface 132.

In an embodiment, different components of a user device interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the user device interface may be specified in one or more other languages, such as Java, C, or C++.

Additionally, or alternatively, the system 100 may include at least one communications interface 134 communicatively coupled or couplable with the test suite generation orchestrator 102, the one or more data repositories 104, and/or the user device interface 132. The at least one communications interface 134 may include hardware and/or software configured to transmit data between respective components of the system and/or to transmit data to and/or from the system. For example, a communications interface 134 may transmit and/or receive data between and/or among one or more of the following: the test suite generation orchestrator 102, the one or more data repositories 104, or the user device interface 132.

### 3. EXAMPLE OPERATIONS FOR GENERATING TEST SUITES

Referring to FIGS. 2A-2C, example operations 200 pertaining to the test suite generation system are further described. One or more operations 200 described with reference to FIGS. 2A-2C may be modified, combined, rearranged, or omitted. Accordingly, the particular sequence of operations 200 described with reference to FIGS. 2A-2C should not be construed as limiting the scope of one or more embodiments. In one example, the operations 200 may be performed by the one or more components of the system described herein.

In one example, the machine learning model generates a test suite for a code module based on a single input prompt. FIG. 2A shows an example set of operations for generating a test suite based on a single input prompt.

Additionally, or alternatively, one or more machine learning models may generate a test suite for a code module based on a series of input prompts. When generating a test suite based on a series of input prompts, an output generated by a machine learning model based on an input prompt is utilized to generate a subsequent input prompt for a machine learning model to generate a subsequent output prompt. FIG. 2B shows an example set of operations for generating a test suite based on a series of input prompts.

In one example, the test suite generation system trains one or more machine learning models to generate test suites based on a single input prompt. FIG. 2C shows an example set of operations for training a machine learning model to generate a test suite based on a single input prompt.

### A. Generating a Test Suite Based on a Single Input Prompt

Referring to FIG. 2A, the system performs operations 200 pertaining to utilizing machine learning models to generate test suites for testing code modules. As shown in FIG. 2A, the system accesses a code module (Operation 202). The code module may be provided to the system via an input such as from a user device interface. Additionally, or alternatively, the system may access the code module from a data repository. The system may generate one or more test suites for one or more code modules.

The system constructs an input prompt that includes a code module and an instruction for a machine learning model to generate, based on a specification for the code module, a test suite that includes a set of tests for testing the code module (Operation 204). The code module may include one or more units of code. The test suite generated in response to the input prompt may include a set of tests for testing the code module to verify that the one or more units of code successfully execute in accordance with the specification for the code module. The tests may include unit tests that are executed upon the code module to test normal conditions and/or edge cases that may be encountered by the code module.

In one example, the system constructs input prompt automatically in response to receiving the code module. In one example, the system receives an input from a user device interface. The system may construct the input prompt based on the input from the user device interface. Additionally, or alternatively, the user device interface may include the input prompt. The input prompt may include a request to generate a test suite for performing one or more types of testing on the code module. The input prompt may include the code module and/or a reference to a location in a data repository where the system may retrieve the code module. Additionally, or alternatively, the input prompt may include a specification for the code module, or the input prompt may include an instruction for a machine learning model to generate the specification. The one or more types of testing may include one or more of the following: a unit test, an integration test, a system test, a functional test, an end-to-end test, or a regression test.

After constructing the input prompt, the system directs the input prompt to the machine learning model (Operation 206). In one example, the system utilizes an application programming interface (API) to direct the input prompt to the machine learning model. Additionally, or alternatively, the system may utilize a CLI to direct the input prompt to the machine learning model. A user or a software application may enter the input prompt as a command-line argument. The CLI may include a CLI script that directs the input prompt to the machine learning model. Additionally, or alternatively, a software application may include instructions for constructing input prompts and directing the input prompts to the machine learning model. In one example, the system includes an automated data pipeline where input prompts are constructed and/or received from one or more sources and automatically directed to the machine learning model.

The machine learning model receives the input prompt. In response to receiving the input prompt, the machine learning model generates a test suite that includes test code for testing the code module. The machine learning model generates the test suite based on a specification for the code module. In one example, the machine learning model generates the specification for the code module and then generates the test suite based on the specification generated by the machine learning model. The test suite includes a set of tests for testing the code module to verify that the one or more units of code successfully execute in accordance with the specification. The test suite includes code for executing the set of tests on the code module. The machine learning model may generate the specification for the code module prior to generating the test suite for the code module. Additionally, or alternatively, the system may provide the specification as an input to the machine learning model.

In one example, the machine learning model generates a plain language explanation of the specification. The machine learning model may generate the plain language explanation of the specification based at least in part on one or more examples. The one or more examples may include an example code module and an example formal specification for the example code module. The machine learning model may generate the test suite based at least in part on the plain language explanation of the specification. Additionally, or alternatively, the machine learning model may generate a plain language explanation of a set of scenarios to be tested via the test suite. The scenarios may include normal conditions and/or edge cases. The machine learning model may generate the plain language explanation of the set of scenarios based at least in part on the one or more examples that include an example code module and an example formal specification for the example code module. The machine learning model may generate the test suite based at least in part on the plain language explanation of the set of scenarios.

In one example, when generating the specification for the code module, the machine learning model includes one or more method signatures and/or method declarations corresponding to the one or more units of code of the code module. Additionally, or alternatively, the machine learning model may refrain from including the one or more units of code when generating the specification for the code module. A method signature includes a name of a method and a parameter list. The parameter list identifies one or more types and names of parameters that the method can accept. A method declaration includes a name of a method, a return type of the method, and a parameter list that identifies one or more types and names of parameters that the method can accept. In one example, a method declaration may include one or more modifiers, such as one or more access modifiers.

The machine learning model generates an output that includes the test suite for testing the code module. The system receives the output from the machine learning model (Operation 208). The output includes the test suite for testing the code module. The test suite may include executable code for testing the code module. The output may include a specification corresponding to the code module and the test suite for testing the code module. The output may include a description of the tests to be performed by the test suite. The machine learning model may utilize an API or a software application to direct the output of the machine learning model to the system, for example, for further processing. Additionally, or alternatively, the machine learning model may direct the output to a data repository, and the system may retrieve the output from the data repository.

The system may generate multiple test suites for multiple code modules. As shown in FIG. 2A, the system determines whether there is an additional code module for generating a test suite (Operation 210). When the system determines that there is an additional code module, the system returns to operation 204 to construct an input prompt for generating a test suite for the additional code module. When the system determines that there is not an additional code module, the system proceeds to execute a set of one or more tests on a set of one or more code modules based on a set of one or more test suites generated by the machine learning model (Operation 212).

The system may set up a test environment for testing the code module. The system may load the code module and the set of tests from the test suite and then execute the set of tests on the code module. The system may configure the test environment for executing various test scenarios. For example, the system may define variables, configuring paths, or dependencies of the test environment as applicable to the test suite.

Upon having executed the set of tests, the system may generate test results. The test results may indicate whether various tests passed or failed. Additionally, or alternatively, the test results may identify one or more errors or exceptions that occurred when executing the set of tests.

### B. Generating a Test Suite Based a Series of Input Prompts

Referring to FIG. 2B, example operations 240 of the test suite generation system are further described. In one example, the operations 240 described with reference to FIG. 2B represent a set of operations for generating a test suite based on a series of input prompts. In one example, the operations 240 described with reference to FIG. 2B represent a set of operations for generating training data for training machine learning models to generate test suites based on a single input prompt, for example, in accordance with the set of operations described with reference to FIG. 2A. In one example, training data generated based on the operations 240 described with reference to FIG. 2B may be utilized in operations for training a machine learning model described with reference to FIG. 2C.

As shown in FIG. 2B, the system accesses a code module (Operation 242). The code module may be provided to the system via an input such as from a user device interface. Additionally, or alternatively, the system may access the code module from a data repository. The system may generate one or more test suites for one or more code modules. A test suite generated by the system may include tests for performing one or more of the following types of testing on the code module: a unit test, an integration test, a system test, a functional test, an end-to-end test, or a regression test.

The system constructs a first input prompt that includes a code module and an instruction for a first machine learning model to generate, based on the code module, a specification for the code module and a set of test scenarios to be tested upon the code module (Operation 244). In one example, the system constructs an input prompt automatically in response to receiving the code module. In one example, the system receives an input from a user device interface. The system may construct the input prompt based on the input from a user device interface. Additionally, or alternatively, the user device interface may include the input prompt. The input prompt may include a request to generate a formal specification and/or a plain language explanation of the specification. In one example, the first input prompt includes one or more examples of code modules annotated with an example specification.

In one example, the first input prompt includes an instruction for the first machine learning model to generate the specification for the code module based at least in part on one or more examples that include an example code module and an example formal specification corresponding to the example code module. Additionally, or alternatively, the first input prompt includes an instruction for the first machine learning model to generate a plain language explanation of the specification, for example, based at least in part on the one or more examples. Additionally, or alternatively, the first input prompt includes an instruction for the first machine learning model to generate a plain language description of the set of tests to be executed upon the code module. The plain language description may include a description of different scenarios to be tested by the test suite and/or a plain language description of a set of expected outputs of the one or more units of code corresponding to the different scenarios. In one example, the first input prompt may include an instruction for the first machine learning model to include, when generating the specification for the code module, one or more method signatures and/or method declarations corresponding to the one or more units of code. Additionally, or alternatively, the first input prompt may include an instruction for the first machine learning model to refrain from including, when generating the specification for the code module, the one or more units of code.

After constructing the first input prompt, the system directs the first input prompt to the first machine learning model (Operation 246). The system may direct the first input prompt to the first machine learning model utilizing an API, a CLI, or a software application, for example, as described above with reference to FIG. 2A. Based at least in part on the first input prompt, the first machine learning model generates the specification for the code module and the set of test scenarios to be tested upon the code module. The first machine learning model generates a first output that includes the specification for the code module and the set of test scenarios to be tested upon the code module.

The system receives the first output from the first machine learning model (Operation 248). The first output includes the specification for the code module and the set of test scenarios to be tested upon the code module. The set of test scenarios may include a description of the tests to be performed by the test suite. The first machine learning model may utilize an API or a software application to direct the first output of the first machine learning model to the system, for example, for further processing. Additionally, or alternatively, the first machine learning model may direct the first output to a data repository, and the system may retrieve the first output from the data repository.

After receiving the first output, the system constructs a second input prompt for a second machine learning model based on the first output of the first machine learning model (Operation 250). The second machine learning model may be the same machine learning model as the first machine learning model or a different machine learning model. Additionally, or alternatively, the first machine learning model and the second machine learning model may represent different modules of the same machine learning model. The first machine learning model and the second machine learning model may utilize the same algorithms or different algorithms to generate outputs.

The second input prompt includes one or more of the following: the code module, the specification, the set of test scenarios, and an instruction for the second machine learning model to generate, based on the second input prompt, a test suite that includes a set of tests for testing the set of test scenarios on the code module. Additionally, or alternatively, the system may store the specification and/or the set of test scenarios for access by the machine learning module in response to the second input prompt.

In one example, the system constructs the second input prompt automatically in response to receiving the first output from the first machine learning model. In one example, the system receives content for the system to construct the second input prompt from a user device interface. The system may construct the second input prompt based on the content from the user device interface. The second input prompt may include a request to generate a test suite for performing one or more types of testing on the code module. The one or more types of testing may include one or more of the following: a unit test, an integration test, a system test, a functional test, an end-to-end test, or a regression test.

In one example, the second input prompt includes the specification and an instruction for the second machine learning model to generate the test suite based on the specification. The specification may include a plain language description of a formal specification. Additionally, or alternatively, the second input prompt may include the plain language description of the different scenarios to be tested and/or the plain language description of the set of expected outputs of the one or more units of code of the code module corresponding to the different scenarios.

After constructing the second input prompt, the system directs the second input prompt to the second machine learning model (Operation 252). The system may direct the first input prompt to the first machine learning model utilizing an API, a CLI, or a software application, for example, as described above with reference to FIG. 2A.

Based at least in part on the second input prompt, the second machine learning model generates a second output that includes the test suite with the set of tests for testing the set of test scenarios on the code module. The system receives the second output from the second machine learning model (Operation 254). The second output includes the test suite with the set of tests for testing the set of test scenarios on the code module.

The second machine learning model may utilize an API or a software application to direct the second output of the second machine learning model to the system, for example, for further processing. Additionally, or alternatively, the second machine learning model may direct the second output to a data repository, and the system may retrieve the second output from the data repository.

The system may generate multiple test suites for multiple code modules. As shown in FIG. 2B, the system determines whether there is an additional code module for generating a test suite (Operation 256). When the system determines that there is an additional code module, the system returns to operation 244 to construct an additional first input prompt. When the system determines that there is not an additional code module, the system proceeds to execute a set of one or more tests on a set of one or more code modules based on a set of one or more test suites generated by the machine learning model (Operation 258).

The system may set up a test environment for testing the code module, load the code module and the set of tests from the test suite, and then execute the set of tests on the code module. Upon having executed the set of tests in the test environment, the system may generate test results that indicate whether various tests passed or failed. Additionally, or alternatively, the test results may identify one or more errors or exceptions that occurred during the testing process.

### C. Training a Machine Learning Model

Referring to FIG. 2C, the system performs operations 270 pertaining to training machine learning models to generate test suites for testing code modules. In one example, the system trains a machine learning model to generate test suites from a single input prompt based on training data that includes test suites that are generated by one or more machine learning models from a series of input prompts. For example, the system may train a machine learning model to generate test suites in accordance with the operations 240 described with reference to FIG. 2B based on training data that includes test suites generated in accordance with the operations 270 described with reference to FIG. 2C.

As shown in FIG. 2C, the system generates a training example that includes one or more inputs and one or more outputs of one or more machine learning models (Operation 272). The one or more machine learning models are utilized in a multi-prompt process to generate, based on a specification for a code module, a test suite for testing a set of test scenarios on the code module. The training examples include training inputs and training outputs of the one or more machine learning models. The training examples may be generated for the purpose of training a machine learning system to generate test suites based on a single input prompt. Additionally, or alternatively, the training examples may represent inputs and outputs of a machine learning system that utilizes a multi-prompt process. The inputs and outputs of the system that utilizes the multi-prompt process may be provided as inputs to train that system or another system to generate test suites based on a single input prompt. Additionally, or alternatively, the training examples may include training prompts that represent single input prompts that include an instruction to generate a test suite for a code module based on a specification for the code module. The training prompts may include a first instruction to generate a specification for a code module and a second instruction to generate a test suite based on the specification. Additionally, or alternatively, the training prompts may include an instruction to utilize CoT reasoning to generate the specification and then to generate the test suite based on the specification.

In one example, a training example may include a training input and a training output of a first machine learning model utilized, for example, in a multi-prompt process, to generate a specification for a code module and/or a description of a set of testing scenarios for testing the code module. The training input of the first machine learning model may include a training code module and a training instruction to generate a training specification based on the training code module. The training output of the first machine learning model may include a training specification for the training code module and/or a training description of a set of testing scenarios for testing the training code module.

Additionally, or alternatively, the training example may include a training input and a training output of a second machine learning model utilized, for example, in the multi-prompt process, to generate a test suite for the code module based on the specification and/or the description of the set of tests. The training input for the second machine learning model may include at least a portion of the training output of the first machine learning model, such as the training specification and/or the training description of the set of testing scenarios. Additionally, or alternatively, the training input of the second machine learning model may include a training instruction to generate a training test suite, for example, based on the training specification and/or the training description of the set of testing scenarios. The training output of the second machine learning model may include a training test suite generated based on the training input of the second machine learning model. In one example, the training example includes a training prompt that represents a single input prompt to generate a test suite for a code module based on a specification for the code module, the training input and the training output of the first machine learning model utilized in the multi-prompt process, and the training input and the training output of the second machine learning model utilized in the multi-prompt process.

The system may generate multiple training examples that include different sets of inputs and outputs of the one or more machine learning models. As shown in FIG. 2C, the system determines whether there is an additional training example to be generated (Operation 274). When the system determines that there is an additional training example to be generated, the system generates the additional training example.

When the system determines that there is not an additional training example to be generated, for example, after having generated multiple training examples, the system generates a training dataset that includes the multiple training examples (Operation 276).

After generating the training dataset, the system utilizes the training dataset to train a set of one or more machine learning models to generate a test suite that includes a set of tests for testing a code module based on a single input prompt (Operation 278).

### 4. EXAMPLE EMBODIMENTS

A detailed example is described below for purposes of clarity. Components and/or operations described below should be understood as specific examples that may not be applicable to certain embodiments. Accordingly, components and/or operations described below should not be construed as limiting the scope of any of the claims.

### A. Example Input Prompt for Generating a Specification and Edge Cases

In one example, the system provides an input prompt for a machine learning model to generate a specification and edge cases based on a code module. The input prompt may include a prompt to generate a formal specification, such as a JML specification, for the code module. Additionally, or alternatively, the input prompt may include a prompt to generate a plain language specification for the code module and/or to explain the formal specification using plain language. Additionally, or alternatively, the input prompt may include a prompt to annotate the code module with the specification, such as the formal specification, and/or to annotate the code module with the plain language explanation of the specification. In one example, the input prompt includes one or more examples for the machine learning model to reference to assist the machine learning module in generating the specification and/or the edge cases.

The following is an example input prompt for generating a specification and a set of edge cases:
System: you are an expert in annotating Java code with Spec looking at few examples below.

```
Example 1: Java code with annoted JML spec
/*@ requires 0 <= num && num <= Long.MAX_VALUE;
@ ensures \result == num;
@ also
@ requires Long.MIN_VALUE < num && num < 0;
@ ensures \result == −num; @*/
public /*@ pure @*/ long Absolute(long num) {
    if (0 <= num)
        return num;
    else
        return −num;
}
Example 2: Java code with annotated JML spec
//@ decreases n;
//@ maintaining sum == x + y − n && 0 <= n;
while (n > 0) {
    sum = sum + 1;
    n = n − 1;
}
....
Question: Code module to be annotated:
// focal method
public double calculateInterest(double principle, double rate, int time, int n) {
      double r = rate / (n * 100);
      double powTerm = Math.pow((1 + r), n*time);
      double result = principle * powTerm;
      return result − principle;
  }
}
Question1: Looking at the examples, generate JML specification for the code module
below, do not repeat the code in the code module, just include method signatures.
Question 2: Explain the specification in simple English for UNIT-TEST generation
task (in point form).
Question 3: Please provide a set of edge cases for the above program in detail with
expected output for UNIT-TEST generation task (in point form).
```

In one example, the foregoing represents an input prompt constructed at operation 244 of FIG. 2B and directed to a first machine learning module at operation 246 of FIG. 2B.

### B. Example Specification and Edge Cases Generated by a Machine Learning Model

In one example, a machine learning model generates an output based on an input prompt described above in Section 4(A). The output may include a specification and a set of edge cases according to the input prompt. The following is an example output generated by a machine learning model based on an input prompt described in Section 4(A) above:

```
## Spec-annotated-code
‘‘‘java
/*@
  @ public behavior
  @
  @ requires principle >= 0.0 && rate >= 0.0 && time >= 0 && n > 0;
  @ ensures \result >= 0.0;
  @*/
public double calculateInterest(double principle, double rate, int time, int n);
‘‘‘
## Spec-in-English
- The method ‘calculateInterest‘ takes four parameters: ‘principle‘, ‘rate‘, ‘time‘, and
‘n‘.
- The specification states that the method should return a non-negative result when
the inputs are non-negative and ‘n‘ is greater than 0.
```

However, if any of the inputs are negative or if ‘n’ is less than or equal to 0, the method should return ‘Double.NaN’ to indicate an invalid input.

## Edge-cases
- Negative ‘principle‘: When the ‘principle‘ is negative, the method should return
‘Double.NaN‘.
- Negative ‘rate‘: If the ‘rate‘ is negative, the method should return ‘Double.NaN‘.
- Negative ‘time‘: In the case where ‘time‘ is negative, the method should return
‘Double.NaN‘.
- Non-positive ‘n‘: When ‘n‘ is less than or equal to 0, the method should return
‘Double.NaN‘.
- Zero ‘principle‘: If the ‘principle‘ is zero, the method should return 0 as there is no
interest to be calculated.
- Zero ‘rate‘: For a zero ‘rate‘, the method should return the ‘principle‘ amount as
there is no growth or interest accumulation.
- Zero ‘time‘: If ‘time‘ is zero, the method should return the ‘principle‘ amount as no
time has passed for interest accumulation.
- Large ‘n‘: Test with a large value of ‘n‘ to ensure the method handles large inputs
correctly.
- Small ‘n‘: Similarly, test with a small value of ‘n‘ to verify the correctness for small
inputs.
- Negative input combination: Test with various combinations of negative inputs to
ensure the method returns ‘Double.NaN‘ consistently.
- Extreme values: Try extremely large or small values for the inputs to check for
potential overflow or underflow issues.
These edge cases should be considered when generating unit tests to ensure the
‘calculateInterest‘ method behaves correctly and adheres to the specified
requirements.

In one example, the foregoing represents an output received from a machine learning model at operation 248 of FIG. 2B.

### C. Example Input Prompt for Generating a Test Suite

In one example, the system provides an input prompt for a machine learning model to generate a test suite for a code module based on a specification and a set of edge cases for the code module. The input prompt may instruct the machine learning module to generate a test suite for a code module based on a specification and a set of edge cases. The input prompt may include a code module such as the code module described above in Section 4(A). Additionally, or alternatively, the input prompt may include a specification and a set of edge cases for the code module, such as the specification and the set of edge cases described above in Section 4(B). In one example, the specification and the set of edge cases are combined with the code module, for example, in the form of comments to the code module.

The following is an example input prompt for generating a test suite for a code module based on a specification and a set of edge cases for the code module:
Write unit tests for the “calculateInterest” method which calculates compound interest based on principal amount, rate, time period, and number of times interest applied per year.

```
‘‘‘java
public class CompoundInterestCalculator {
/*
Specification:
- The method ‘calculateInterest‘ takes four parameters: ‘principle‘, ‘rate‘, ‘time‘, and
‘n‘.
- The specification states that the method should return a non-negative result when
the inputs are non-negative and ‘n‘ is greater than 0.
- However, if any of the inputs are negative or if ‘n‘ is less than or equal to 0, the
method should return ‘Double.NaN‘ to indicate an invalid input.
Edge cases:
- Negative ‘principle‘: When the ‘principle‘ is negative, the method should return
‘Double.NaN‘.
- Negative ‘rate‘: If the ‘rate‘ is negative, the method should return ‘Double.NaN‘.
- Negative ‘time‘: In the case where ‘time‘ is negative, the method should return
‘Double.NaN‘.
- Non-positive ‘n‘: When ‘n‘ is less than or equal to 0, the method should return
‘Double.NaN‘.
- Zero ‘principle‘: If the ‘principle‘ is zero, the method should return 0 as there is no
interest to be calculated.
- Zero ‘rate‘: For a zero ‘rate‘, the method should return the ‘principle‘ amount as
there is no growth or interest accumulation.
- Zero ‘time‘: If ‘time‘ is zero, the method should return the ‘principle‘ amount as no
time has passed for interest accumulation.
- Large ‘n‘: Test with a large value of ‘n‘ to ensure the method handles large inputs
correctly.
- Small ‘n‘: Similarly, test with a small value of ‘n‘ to verify the correctness for small
inputs.
- Negative input combination: Test with various combinations of negative inputs to
ensure the method returns ‘Double.NaN‘ consistently.
- Extreme values: Try extremely large or small values for the inputs to check for
potential overflow or underflow issues.
These edge cases should be considered when generating unit tests to ensure the
‘calculateInterest‘ method behaves correctly and adheres to the specified
requirements.
*/
  public double calculateInterest(double principle, double rate, int time, int n) {
    double r = rate / (n * 100);
    double powTerm = Math.pow((1 + r), n*time);
    double result = principle * powTerm;
    return result − principle;
  }
}
‘‘‘
```

In one example, the foregoing represents an input prompt constructed at operation 250 of FIG. 2B and directed to a second machine learning module at operation 252 of FIG. 2B.

### D. Example Single Input Prompt for Generating a Test Suite

In one example, a machine learning model generates a test suite based on a single input. The input prompt may instruct the machine learning model to utilize CoT reasoning. In one example, the input prompt includes a code module and an instruction to generate a test suite for the code module based on a specification for the code module. In one example, the input prompt includes an instruction for the machine learning module to generate a specification and a set of edge cases for the code module before generating the test suite. Additionally, or alternatively, the specification may be included in the input prompt.

The following is an example input prompt for a machine learning model to generate a test suite for testing a code module based on a single input prompt:

```
Input:
Write unit tests for the ″calculateInterest″ method which calculates compound interest
based on principal amount, rate, time period, and number of times interest applied per
year.
‘‘‘java
public class CompoundInterestCalculator {
  public double calculateInterest(double principle, double rate, int time, int n) {
    double r = rate / (n * 100);
    double powTerm = Math.pow((1 + r), n*time);
    double result = principle * powTerm;
    return result − principle;
  }
}
‘‘‘
Before generating unit test code, you are required to generate Specification and Edge
cases requirements first, then followed by the unit test code.
```

In one example, the foregoing represents an input prompt constructed at operation 204 of FIG. 2A and directed to a machine learning module at operation 206 of FIG. 2A.

### E. Example Test Suite Generated by a Machine Learning Model

In one example, a machine learning model generates an output that includes a test suite for testing a code module. The test suite may include executable code for testing the code module. A machine learning model may generate the output that includes the test suite based on an input prompt described in Sections 4(C) and/or 4(D) above. The following is an example output generated by a machine learning model based on an input prompt described in Sections 4(C) and/or 4(D) above:

```
‘‘‘java
import static org.junit.jupiter.api.Assertions.*;
import org.junit.jupiter.api.Test;
import org.junit.jupiter.params.ParameterizedTest;
import org.junit.jupiter.params.provider.CsvSource;
import org.junit.jupiter.params.provider.ValueSource;
class CompoundInterestCalculatorTest {
  private CompoundInterestCalculator calculator = new
CompoundInterestCalculator( );
  @ParameterizedTest
  @CsvSource({
    ″−1, 5, 1, 1″,
    ″1, −5, 1, 1″,
    ″1, 5, −1, 1″,
    ″1, 5, 1, −1″,
    ″−1, −5, −1, −1″
  })
  void testNegativeInputs(double principle, double rate, int time, int n) {
    double result = calculator.calculateInterest(principle, rate, time, n);
    assertTrue(Double.isNaN(result));
  }
  @Test
  void testZeroPrinciple( ) {
    double result = calculator.calculateInterest(0, 5, 1, 1);
    assertEquals(0, result);
  }
  @Test
  void testZeroRate( ) {
    double result = calculator.calculateInterest(1, 0, 1, 1);
    assertEquals(1, result);
  }
  @Test
  void testZeroTime( ) {
    double result = calculator.calculateInterest(1, 5, 0, 1);
    assertEquals(1, result);
  }
  @ParameterizedTest
  @ValueSource(ints = {Integer.MAX_VALUE, Integer.MIN_VALUE})
  void testLargeN(int n) {
    double result = calculator.calculateInterest(1, 5, 1, n);
    assertTrue(Double.isNaN(result));
  }
  @ParameterizedTest
  @ValueSource(ints = {1, 2, 3, 4, 5})
  void testSmallN(int n) {
    double result = calculator.calculateInterest(1, 5, 1, n);
    assertTrue(Double.isFinite(result));
  }
  @ParameterizedTest
  @CsvSource({
    ″−1, 5, 1, 1″,
    ″1, −5, 1, 1″,
    ″1, 5, −1, 1″,
    ″1, 5, 1, −1″,
    ″−1, −5, −1, −1″
  })
  void testNegativeInputCombinations(double principle, double rate, int time, int n)
{
    double result = calculator.calculateInterest(principle, rate, time, n);
    assertTrue(Double.isNaN(result));
  }
  @ParameterizedTest
  @CsvSource({
    ″1, 5, 1, 1″,
    ″1, 5, 1, 2″,
    ″1, 5, 1, 3″,
    ″1, 5, 1, 4″,
    ″1, 5, 1, 5″
  })
  void testExtremeValues(double principle, double rate, int time, int n) {
    double result = calculator.calculateInterest(principle, rate, time, n);
    assertTrue(Double.isFinite(result));
  }
}
‘‘‘
```

In one example, the foregoing represents an output received from a machine learning model at operation 208 of FIG. 2A. Additionally, or alternatively, the foregoing may represent an output received from a machine learning model at operation 254 of FIG. 2B.

### F. Training Example for Training a Machine Learning Model to Generate a Test Suite

In one example, the system generates a training dataset that includes a set of training examples for training a machine learning model to generate a test suite for testing a code module based on a single input prompt. The training example may include a set of input prompts and set of output prompts corresponding to the set of input prompts generated by one or more machine learning models in a multi-prompt process. In one example, the training dataset includes an input prompt described in Section 4(A) above, an output described in Section 4(B) above, an input described in Section 4(C) above, and an output described in Section 4(E) above. In one example, a training dataset includes the following training example:
Input:
Write unit tests for the “calculateInterest” method which calculates compound interest based on principal amount, rate, time period, and number of times interest applied per year.

```
‘‘‘java
public class CompoundInterestCalculator {
  public double calculateInterest(double principle, double rate, int time, int n) {
    double r = rate / (n * 100);
    double powTerm = Math.pow((1 + r), n*time);
    double result = principle * powTerm;
    return result − principle;
  }
}
‘‘‘
```

Before generating unit test code, you are required to generate Specification and Edge cases requirements first, then followed by the unit test code.

Output:
Specification:
- The method ‘calculateInterest‘ takes four parameters: ‘principle‘, ‘rate‘, ‘time‘, and
‘n‘.
- The specification states that the method should return a non-negative result when
the inputs are non-negative and ‘n‘ is greater than 0.
- However, if any of the inputs are negative or if ‘n‘ is less than or equal to 0, the
method should return ‘Double.NaN‘ to indicate an invalid input.
Edge cases:
- Negative ‘principle‘: When the ‘principle‘ is negative, the method should return
‘Double.NaN‘.
- Negative ‘rate‘: If the ‘rate‘ is negative, the method should return ‘Double.NaN‘.
- Negative ‘time‘: In the case where ‘time‘ is negative, the method should return
‘Double.NaN‘.
- Non-positive ‘n‘: When ‘n‘ is less than or equal to 0, the method should return
‘Double.NaN‘.
- Zero ‘principle‘: If the ‘principle‘ is zero, the method should return 0 as there is no
interest to be calculated.
- Zero ‘rate‘: For a zero ‘rate‘, the method should return the ‘principle‘ amount as
there is no growth or interest accumulation.
- Zero ‘time‘: If ‘time‘ is zero, the method should return the ‘principle‘ amount as no
time has passed for interest accumulation.
- Large ‘n‘: Test with a large value of ‘n‘ to ensure the method handles large inputs
correctly.
- Small ‘n‘: Similarly, test with a small value of ‘n‘ to verify the correctness for small
inputs.
- Negative input combination: Test with various combinations of negative inputs to
ensure the method returns ‘Double.NaN‘ consistently.
- Extreme values: Try extremely large or small values for the inputs to check for
potential overflow or underflow issues.

These edge cases should be considered when generating unit tests to ensure the ‘calculateInterest’ method behaves correctly and adheres to the specified requirements.

```
‘‘‘java
import static org.junit.jupiter.api.Assertions.*;
import org.junit.jupiter.api.Test;
import org.junit.jupiter.params.ParameterizedTest;
import org.junit.jupiter.params.provider.CsvSource;
import org.junit.jupiter.params.provider.ValueSource;
class CompoundInterestCalculatorTest {
  private CompoundInterestCalculator calculator = new
CompoundInterestCalculator( );
  @ParameterizedTest
  @CsvSource({
    ″−1, 5, 1, 1″,
    ″1, −5, 1, 1″,
    ″1, 5, −1, 1″,
    ″1, 5, 1, −1″,
    ″−1, −5, −1, −1″
  })
  void testNegativeInputs(double principle, double rate, int time, int n) {
    double result = calculator.calculateInterest(principle, rate, time, n);
    assertTrue(Double.isNaN(result));
  }
  @Test
  void testZeroPrinciple( ) {
    double result = calculator.calculateInterest(0, 5, 1, 1);
    assertEquals(0, result);
  }
  @Test
  void testZeroRate( ) {
    double result = calculator.calculateInterest(1, 0, 1, 1);
    assertEquals(1, result);
  }
  @Test
  void testZeroTime( ) {
    double result = calculator.calculateInterest(1, 5, 0, 1);
    assertEquals(1, result);
  }
  @ParameterizedTest
  @ValueSource(ints = {Integer.MAX_VALUE, Integer.MIN_VALUE})
  void testLargeN(int n) {
    double result = calculator.calculateInterest(1, 5, 1, n);
    assertTrue(Double.isNaN(result));
  }
  @ParameterizedTest
  @ValueSource(ints = {1, 2, 3, 4, 5})
  void testSmallN(int n) {
    double result = calculator.calculateInterest(1, 5, 1, n);
    assertTrue(Double.isFinite(result));
  }
  @ParameterizedTest
  @CsvSource({
    ″−1, 5, 1, 1″,
    ″1, −5, 1, 1″,
    ″1, 5, −1, 1″,
    ″1, 5, 1, −1″,
    ″−1, −5, −1, −1″
  })
  void testNegativeInputCombinations(double principle, double rate, int time, int n)
{
    double result = calculator.calculateInterest(principle, rate, time, n);
    assertTrue(Double.isNaN(result));
  }
  @ParameterizedTest
  @CsvSource({
    ″1, 5, 1, 1″,
    ″1, 5, 1, 2″,
    ″1, 5, 1, 3″,
    ″1, 5, 1, 4″,
    ″1, 5, 1, 5″
  })
  void testExtremeValues(double principle, double rate, int time, int n) {
    double result = calculator.calculateInterest(principle, rate, time, n);
    assertTrue(Double.isFinite(result));
  }
}
‘‘‘
```

In one example, the foregoing training example may be utilized to train a machine learning model to generate a test suite based on a single input prompt. Additionally, or alternatively, the foregoing training example may be utilized to retrain a machine learning model to generate a test suite in a process that utilizes multiple input prompts.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread). A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared among multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, one or more of the following: Software-as-a-Service (SaaS), Platform-as-a-Service (PaaS), or Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, one or more of the following: a private cloud, a public cloud, or a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications that are designed as a single fixed unit and generally comprise a single logical executable. With microservice applications, different microservices are independently deployable as separate executables. Microservices may communicate using HTTP messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.).

### Triggers

The techniques described above may be encapsulated into a microservice according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and indicate whether to increase, decrease, or delete the threshold. Additionally, or alternatively, the input might request the microservice application to create new in-application alert thresholds. The in-application alerts may trigger alerts to the user while logged into the application or may trigger alerts to the user using default or user-selected alert mechanisms available within the microservice application itself rather than through other applications plugged into the microservices manager.

In one or more embodiments, the microservice application may generate and provide an output based on input that identifies, locates, or provides historical data and defines the extent or scope of the requested output. The action, when triggered, causes the microservice application to provide, store, or display the output, for example, as a data model or as aggregate data that describes a data model.

### 7. HARDWARE OVERVIEW

According to one embodiment, the techniques described herein are implemented by one or more special-purpose computing devices. The special-purpose computing devices may be hard-wired to perform the techniques or may include digital electronic devices, such as one or more application-specific integrated circuits (ASICs), field programmable gate arrays (FPGAs), or network processing units (NPUs) that are persistently programmed to perform the techniques. Also, the special-purpose computing devices may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

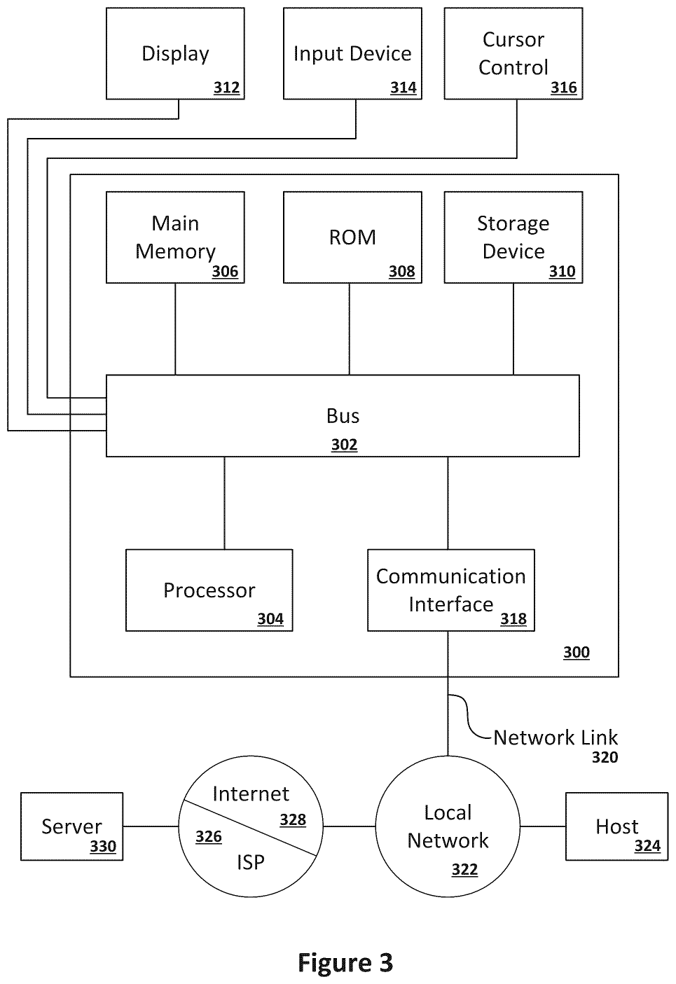

For example, FIG. 3 is a block diagram that illustrates a computer system 300 upon which an embodiment of the disclosure may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or a Solid-State Drive (SSD) is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware, and/or program logic that in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic, or optical signals that carry digital data streams. The signals through the various networks and the signals on network link 320 and through communication interface 318, that carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
accessing a code module comprising one or more units of code;
constructing one or more input prompts for a machine learning system comprising one or more machine learning models, the one or more input prompts instructing the machine learning system to generate, based on a specification for the code module, a test suite comprising a set of tests for testing the code module to verify that one or more units of code successfully execute in accordance with the specification,
wherein the specification comprises (a) one or more preconditions that precede successful execution of the one or more units of code and (b) one or more postconditions that exist following successful execution of the one or more units of code;
directing the one or more input prompts to the machine learning system, wherein the machine learning system receives the one or more input prompts and generates the test suite in response to receiving the one or more input prompts;
receiving, from the machine learning system, a set of one or more outputs comprising the test suite;
storing and/or transmitting the test suite for use in testing the code module.

2. The one or more non-transitory computer-readable media of claim 1, wherein, based on the one or more input prompts:
the machine learning system generates a first plain language explanation of the specification based at least in part on a set of one or more examples comprising an example code module and an example formal specification for the example code module; and
the machine learning system generates the test suite based at least in part on the first plain language explanation of the specification.

3. The one or more non-transitory computer-readable media of claim 2,
wherein the machine learning system generates a second plain language explanation of a set of edge cases based at least in part on the set of one or more examples; and
wherein the machine learning system generates the test suite based at least in part on the second plain language explanation of the set of edge cases.

4. The one or more non-transitory computer-readable media of claim 1, wherein constructing the one or more input prompts comprises:
constructing a first input prompt comprising a first instruction for a first machine learning model to generate the specification for the code module based at least in part on an example code module and an example formal specification corresponding to the example code module.

5. The one or more non-transitory computer-readable media of claim 4, wherein the first input prompt comprises:
a second instruction for the first machine learning model to include, when generating the specification for the code module, at least one of:
one or more method signatures corresponding to the one or more units of code, or
one or more method declarations corresponding to the one or more units of code; and
a third instruction for the first machine learning model to refrain from including, when generating the specification for the code module, the one or more units of code.

6. The one or more non-transitory computer-readable media of claim 4, wherein the first input prompt comprises:
a second instruction for the first machine learning model to generate a plain language explanation of the specification; and
a third instruction for the first machine learning model to generate (i) a first plain language description of the set of tests, and (ii) a second plain language description of a set of expected outputs of the one or more units of code when executing the set of tests.

7. The one or more non-transitory computer-readable media of claim 4, wherein constructing the one or more input prompts comprises:
constructing a second input prompt comprising the specification and a second instruction for a second machine learning model to generate the test suite based on the specification.

8. The one or more non-transitory computer-readable media of claim 7, wherein the specification comprises a plain language description of a formal specification.

9. The one or more non-transitory computer-readable media of claim 7, wherein the second input prompt comprises:
a first plain language description of the set of tests, and
a second plain language description of a set of expected outputs of the one or more units of code when executing the set of tests.

10. The one or more non-transitory computer-readable media of claim 1, wherein constructing the one or more input prompts comprises:
constructing an input prompt for the machine learning system, the input prompt comprising the code module and a set of instructions for the machine learning system to generate the test suite based on the specification for the code module,
wherein the machine learning system utilizes chain of through reasoning to generate the test suite based on the input prompt.

11. The one or more non-transitory computer-readable media of claim 10, wherein the set of instructions comprises:
a first instruction to generate the specification; and
a second instruction to generate the test suite based on the specification.

12. The one or more non-transitory computer-readable media of claim 11,
wherein the first instruction further instructs a machine learning model to generate a description of the set of tests; and
wherein the second instruction instructs the machine learning model to generate the test suite further based on the description of the set of tests.

13. The one or more non-transitory computer-readable media of claim 1, wherein the operations comprise:
constructing a first input prompt for a first machine learning model, the first input prompt comprising the code module and a first set of instructions for the first machine learning model to generate the specification for the code module;
receiving, from the first machine learning model, a first output comprising the specification for the code module;
constructing a second input prompt for a second machine learning model, the second input prompt comprising the specification, the code module, and a second set of instructions for the second machine learning model to generate the test suite for the code module based on the specification for the code module; and
receiving, from the second machine learning model, a second output comprising the test suite.

14. The one or more non-transitory computer-readable media of claim 13,
wherein the first set of instructions further instruct the first machine learning model to generate a description of the set of tests;
wherein the first output further comprises the description of the set of tests; and
wherein the second input prompt further comprises the description of the set of tests and wherein the second set of instructions further instruct the second machine learning model to generate the test suite further based on the description of the set of tests.

15. The one or more non-transitory computer-readable media of claim 1, wherein the operations further comprise:
generating a training example comprising:
a training input of a first machine learning model and a training output of the first machine learning model corresponding to the training input,
the first machine learning model utilized in a multi-prompt process to generate, based on a first training specification for a training code module, a first training test suite comprising a first set of training tests for testing the training code module; and
a training prompt for training a second machine learning model to generate the test suite based on a single input prompt;
utilizing the training example to train the second machine learning model to generate the test suite based on the single input prompt.

16. The one or more non-transitory computer-readable media of claim 15,
wherein the training input comprises the training code module;
wherein the training output comprises:
the first training specification generated in the multi-prompt process;
the first training test suite generated based on the first training specification;
wherein the training prompt comprises:
a first training instruction to generate a second training specification for the training code module,
a second training instruction to generate, based on the second training specification, a second training test suite comprising a second set of training tests for testing the training code module.

17. The one or more non-transitory computer-readable media of claim 1, wherein the set of tests comprises a set of unit tests for execution upon the code module to evaluate a set of edge cases.

18. The one or more non-transitory computer-readable media of claim 1, wherein a computing device component accesses the test suite and the code module, executes the set of tests upon the code module, and generates a set of test results based on the set of tests executed upon the code module, and, wherein the test suite comprises code for executing the set of tests on the code module.

19. A method, comprising:
accessing a code module comprising one or more units of code;
constructing one or more input prompts for a machine learning system comprising one or more machine learning models, the one or more input prompts instructing the machine learning system to generate, based on a specification for the code module, a test suite comprising a set of tests for testing the code module to verify that one or more units of code successfully execute in accordance with the specification,
wherein the specification comprises (a) one or more preconditions that precede successful execution of the one or more units of code and (b) one or more postconditions that exist following successful execution of the one or more units of code;
directing the one or more input prompts to the machine learning system, wherein the machine learning system receives the one or more input prompts and generates the test suite in response to receiving the one or more input prompts;
receiving, from the machine learning system, a set of one or more outputs comprising the test suite;
storing and/or transmitting the test suite for use in testing the code module;
wherein the method is performed by at least one device including a hardware processor.

20. A system comprising:
at least one device including a hardware processor;
the system being configured to perform operations comprising:
accessing a code module comprising one or more units of code;
constructing one or more input prompts for a machine learning system comprising one or more machine learning models, the one or more input prompts instructing the machine learning system to generate, based on a specification for the code module, a test suite comprising a set of tests for testing the code module to verify that one or more units of code successfully execute in accordance with the specification,
wherein the specification comprises (a) one or more preconditions that precede successful execution of the one or more units of code and (b) one or more postconditions that exist following successful execution of the one or more units of code;
directing the one or more input prompts to the machine learning system, wherein the machine learning system receives the one or more input prompts and generates the test suite in response to receiving the one or more input prompts;
receiving, from the machine learning system, a set of one or more outputs comprising the test suite;
storing and/or transmitting the test suite for use in testing the code module.
